(19) United States
(12) Patent Application Publication
(10) Pub. No.: US 2009/0138350 A1
(43) Pub. Date: May 28, 2009

(54) Application of printed and graphic media onto a payment check stub & method of use thereof

(76) Inventor: Donald Neumann, Vicksburg, MS (US)

Correspondence Address: Donald Neumann, 5 Bugle Ridge Drive, Vicksburg, MS, 39180, US

(21) Appl. No.: 11/986,541

(22) Filed: Nov. 23, 2007

(51) Int. Cl. G06Q 30/00; G06Q 20/00

(52) U.S. Cl. 705/14; 705/39

(57) ABSTRACT

The invention relates generally to the field of apparatus for applying print and graphical images and communications media to a payment check stub. Moreover, it applies specifically to a process of applying printed media and graphics that includes advertisement and a plurality of other useful information to a payment check stub with the image being “imprinted” on the check stub in “real time” during the “check printing” process and capable of being easily “varied” by non-technical personnel with each printing of the payment checks and check stubs.

The invention is a unique, novel, and nonobvious process for dynamically applying communicating information, alerts, and advertising on a plurality of paper check payments and/or the employee payroll payment on the check stub and direct deposit advice as an integral part of the check payments and the employee payroll check processing functions.

### CROSS REFERENCE TO RELATE APPLICATIONS

No claim is made of benefit of prior non-provisional applications (or international applications designating the United States of America) under 35 USC §§ 120, 121 or 365(c).

I claim benefit of the filing of a provisional Patent Application No. 60/867,633 with the Filing Date of Nov. 29, 2006 and confirmation number 2560 date mailed Jan. 16, 2007.

### STATEMENT REGARDING FEDERALLY SPONSORED RESEARCH OR DEVELOPMENT

This is not applicable.

### FIELD OF THE INVENTION

The invention pertains generally to a nonobvious and unique method of advertising, and communication of information by which a print or graphic image is created and impressed on the stub of payment checks. It specifically involves applying the image on the “face” of the check stub of the employee payroll earnings, third party and individual payment checks at “check printing” and dynamically and on-the-fly in “real time” with the option to “vary” the content at each check printing by non-technical personnel.

Consumer purchasing within the United States alone extends into the trillions of dollars annually, while advertisers expend billions of dollars annually in an effort to reach consumers. Advertising expenditure generally has two purposes: first to educate the public on benefits of purchasing a given product or service, and second to develop name recognition (branding). The theory behind increased name recognition is that a higher level of name exposure tends to create a sense of product or service desirability on the part of the consumer and the recollection of a particular and preferred brand during a purchasing decision.

Conventional advertising may involve magazines and newspapers that are purely passive in nature. They may require research on the part of the individual, but only the talent and ability to read. More recently Internet Search engines link words to advertisements to promote sales of goods and services. and this requires access to a computer and computer literacy.

Our modern and fast moving society of today requires constant and sometimes complex transfer of information that is best and most efficiently delivered at the “point of action”. Citizens, individuals, companies and corporate employees that are recipients of payments and payroll checks invariably receive a memo or check stub that identifies the nature of the payment transaction. Advertising thereon is the perfect opportunity to create the link between the prospect and the service or product at the time of conversion of the check to cash or payment which is frequently when the recipient is shopping on payday.

The principal factor in check stub advertising and communication involves “point of action” attraction and garnering the attention of the recipient at the very time the check and check stub are in hand and in process of deposit or conversion to cash. An important factor in achieving success from the payroll function is when the cash is in-hand and the advertising and appropriate information conveniently occur on the pay period and during which many employees do their buying or paying of expenses. For this reason, “point of purchase” advertising and “targeted” communication are an efficient means to influence the consumer and individual while they convert the negotiable instrument of the payroll or payment check into a deposit, cash, or payment.

Patents have involved a method and system for advertising on business forms. They are generalized for advertising to target a market of employees through placement of advertisement on employers business forms. They may involve the collection of information about employees and about advertisements from advertisers and then match employee information to the desired target audience of advertisements. They frequently describe a method for offsetting the costs related to business form production by applying a portion of revenue received from advertising space on a business form to the costs related to the production of the business form.

Patents exist that pertain to checks and check stubs, only so far, as they are a vehicle to which preprinted negotiable coupons and documents are attached to the check and check stub for exchange for goods and services. In addition, they frequently state “by which advertisements can be placed on the back of the employee pay stubs and the like” where they are out-of-sight. They require pre-printing of the information that can not be changed or varied until the stock of checks, etc. are replenished.

In U.S. Pat. No. 5,992,888, titled Advertising Device and Method for Use at Point of Sale, a transaction recording card for recording credit and debit purchases is disclosed. Third party advertising is placed on the card in a format that may be viewed by the purchaser at the time of making and recording a transaction. The device comprises a transaction ledger on an obverse side and an advertising space on a reverse or backside. Therefore, if a consumer chooses to use the recording ledger for recording debit and credit card purchases, the invention provides a method of achieving frequent point of purchase advertising.

In U.S. Pat. No. 4,722,554, titled Alternative-Value Paper Refund Form, a form having obverse and reverse sides is disclosed. The obverse side comprises a negotiable instrument and an optional advertisement, while the reverse side comprises coupons or other alternative value incentives. The form is arranged so that the coupons on the reverse side partially overlap the negotiable instrument on the obverse side. Therefore, if a holder removes the negotiable instrument, the alternative coupons or value incentive is destroyed. The patented invention is designed to provide consumers with a choice: consumers can either “cash the check” or “use the coupon”, but they cannot do both. This type of design is particularly useful for bulk mailing contest entry forms containing small checks and coupons as incentives to enter a contest.

In U.S. Pat. No. 5,823,575, titled. Advertising Check, a check having advertising information printed thereon is provided. The invention discloses a picture or design on a negotiable personal or company bank check. It further discloses a photograph or image in the background of the check for the purpose of advertising and promoting a particular product. The patented invention does potentially expose consumers to point of action advertising. However, the consumer's exposure to advertising on the check is limited and lost when the payee deposits the check and converts it to cash or credit. There is no advertising or information on the check stub and the information on the check can not be changed until the check stock is replenished.

In French patent FR 2612325 A, titled Advertising Message Medium, and Method for Making Use of the Said Support, a combined check and advertising medium is disclosed. The check consists of a normal bank check which is extended by an additional panel upon which is printed advertising material from either the bank, the account holder, or a third party. In addition, the advertising panel may have perforations so that it can be detached from the check. Like U.S. Pat. No. 5,823,575, the patented invention provides a method for exposing consumers to point of action advertising, as they are more likely to make purchases soon after receiving a check. The invention does not address the check stub itself.

Numerous Internet web sites were reviewed to establish the existence of Prior Art. A web site of a large company, referenced the employee alert of “Safety First” that was pre-printed on the check stub. It was pre-printed on the check stock as part of the conventional check and check stub format along with the company name and address, etc. It was not trademarked or patented.

AOL and others found ChekAds LLC. They offer free check printing paper stock to their clients. “ChekAds was developed to provide affordable and effective advertising by pre-printing ads on the back of payroll paycheck stubs and direct deposit slips.” This company is no longer in business.

Ask.com and some others found Check-Solutions.com who initially sold “pre-printed” advertising space on the back side of the payroll checks and deposit slips. Check-Solution was acquired by Carreker, who was acquired by CheckFree, who is being acquired by Fiserv, who now specializes in consulting and services to the Financial Industry.

None of the hundreds of other sites, news releases, databases, blogs, advertisers, journals, articles and abstracts referenced or addressed any of these terms in the References reveal Prior Art.

Advertisers generally target consumers most likely to purchase a given product or service. This invention addresses the need for cash money to purchase products by a target audience of employee consumers with paying jobs and of individuals and citizens who are in receipt of payments by check and direct deposit. However, there is no method to target and efficiently reach the 150-million working Americans who receive paychecks and pay stubs, and direct deposit advice stubs. There is no medium for reaching the 300-million citizens who may be recipients of government check payment. There is no medium that provides for “dynamically” replacing the graphic or printed information of the invention during the check and check stub printing process in “real time”.

### SUMMARY OF THE INVENTION

In view of the limitations now present in Prior Art, the present invention provides a new and useful Application of Printed Media onto a Payment Check Stub & Method of use Thereof, which is simpler in construction, more universally usable and more versatile in operation than all known applications of this kind.

The purpose of the present invention is to provide a new Application of Printed Media onto a Payment Check Stub & Method of use Thereof which will deliver advertisements, corporate and government information and alerts, and or other intended information, to targeted individuals and companies and employees via payments and paychecks with a photograph, graphical image, or typed information on the face of the associated and attached check stub for “point of action” benefit on the recipients receipt of the payment check and check stub and for providing an available record that the recipient can retain for reference purposes.

It is the purpose of the invention to provide a new Application of Printed Media onto a Payment Check Stub & Method of use Thereof that has many novel features not offered by the Prior Art and that result in a new Application of Printed Media onto a Payment Check Stub & Method of use Thereof which is not apparent, obvious, or suggested, either directly or indirectly by any Prior Art apparatus.

The present invention generally comprises a media content source, a media content intended recipient, and a main media content display area whereon the media content is printed for presentation to the intended recipient, whereby the media content source may be individual, business, corporate and or government entities, and whereby the media content may include graphical images, photographs, and or printed visualizations or text which may create an advertisement, coupon, message, notification, alert, announcement, offering of services and or other information intended to be intimated or distributed to the intended recipient.

The computer and check printer, or check printing machine imprints the advertisement, alerts and information on the face of the stub of the check of an employee paycheck, direct deposit advice, and third party and individual payments as part of the payment and check processing function in “real time”. The graphical images are co-mingled with the conventional check stub information well in advance of the imprinting to eliminate conflict for space on the check stub and to do so “without preprinting” the images in advance of the check and check stub printing process.

The information to be imprinted on the “face” of the check stub may be gathered in advance, or entered “immediately” to support a plurality of uses before the check and check stub printing function. The advertising, information or graphical image is created using conventional computer technology and stored on diskette, magnetic media, or electronic means for conventional entry into the computer or check printing machine.

It is further intended that the image(s) can be distributed to the payment check printing activity by any conventional means and deposited in the computer, or check printing system, so as to be dynamically available for use in the normal course of the check and check stub printing process. The image distribution can be made a part of the conventional tax update and regulation update process for employee payroll. The distribution can be made a part of any system for processing accounts payable to individuals or to business enterprises. Alternatively, the local check printing function may create its own image(s) and information.

During the payment check printing process the image(s) are co-mingled on available space on the face of the check stub on a predefined and non-interference basis with the conventional check stub information.

It is to be further understood that the graphical image(s) may benefit from the use of color and photography to garner attention thereto in contrast to the conventional check stub information that is typically in typed format.

The utility invention disclosed herein creates a novel and innovative process of imprinting a graphical communication on the “face” of the check stub that includes commercial advertisements, corporate and government information and alerts, and or other intended information not referred to herein which is to be considered apparent and obvious to the disclosure, whereby the source of the created media content communication may target their intended recipients including, target markets, individuals, and or employees.

The foregoing has described the physical aspects of the invention and is to serve as an aid to better understanding the intended use and application of the invention. In reference to such, the present examples and embodiments are to be considered as illustrative and not restrictive, and that the invention is not limited to the method or detail of construction, fabrication, material, or application of use described and illustrated herein. Any other variation of fabrication, use, or application should be considered apparent as an alternative embodiment of the present invention.

### DESCRIPTION OF THE DRAWINGS

FIG. 1 is a view of an embodiment of a typical “pre-printed” blank check and check stub conventionally used prior to this invention.

FIG. 2 is a view of an embodiment of a typical blank check and check stub that may optionally be used in the apparatus of the invention to concurrently apply both the normally printed check and check stub format and the communication information during the check printing process.

FIG. 3 is a view of an embodiment of a typical completely processed check and check stub payment ready for distribution to an employee or payee without the communication information.

FIG. 4 is a view of an embodiment of a typical check stub and check employing “point of action” advertising or communication and distribution of information in the invention.

FIG. 5 is a view of an embodiment of a typical check stub and check employing “branding” advertising or communication and distribution of information in the invention.

FIG. 6 is a view of an embodiment of a typical check stub and check used for conveying company or government alerts or information in the invention.

### DETAILED DESCRIPTION OF THE INVENTION

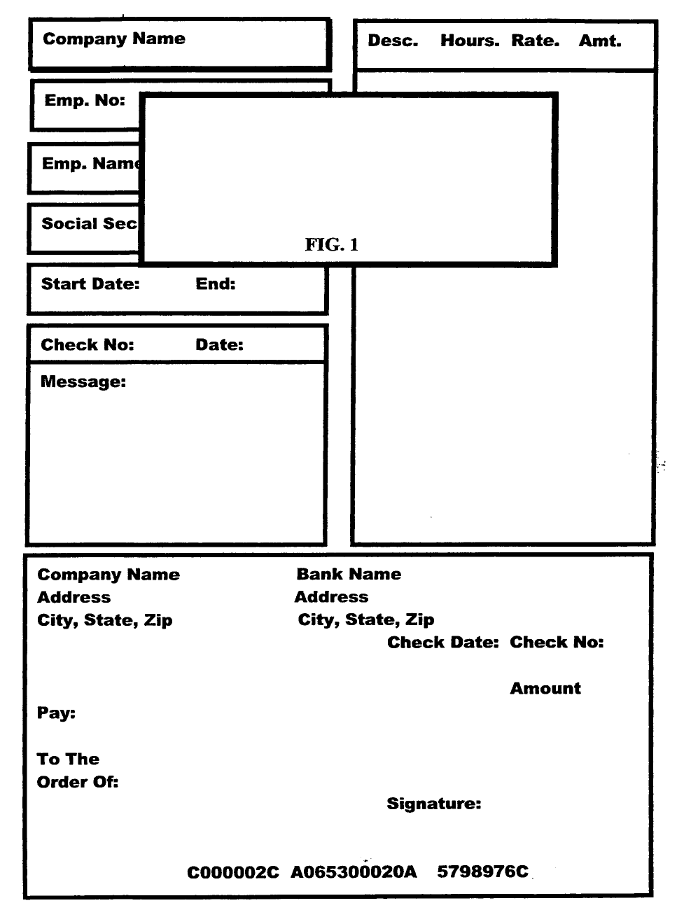

A principal object of the invention is to provide an Application of Printed Media onto a Payment Check Stub & Method of use Thereof that will overcome the deficiencies of the Prior Art devices. FIG. 1 exemplifies the typical employee payment check and stub prior to the invention. It uses the conventional pre-printed check stock before the payment information is applied in the check and check stub printing process. This requires a supply of pre-printed check stock the content and format of which is not normally changed until the supply is exhausted.

An object of the invention is to provide an Application of Printed Media onto a Payment Check Stub & Method of use Thereof that will support the incorporation of the plurality of advertisements, images, graphics, alerts & notifications, and a multitude of other information into the process immediately before the check printing process by regular office personnel.

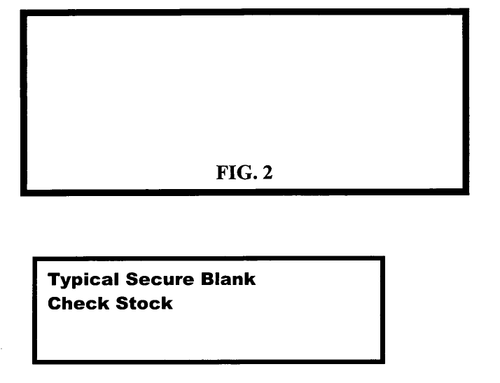

FIG. 2 is a view of an embodiment of the blank check and check stub paper stock that may optionally be used in the apparatus of the invention before the normally per-printed printed check and check stub format and the conventional payment information is applied during the check printing process. This invention feature additionally provides a plurality of check and check stub formats as company situations change. The formats may be readily varied at run-time, since they are applied in the same manner as the advertising and company information. This eliminates the requirement for modifying the hard coded computer instructions in the computer program commonly used in the industry for the purpose of defining the check-check stub format, or the need to reprint and replace the supply of paper payment check stock.

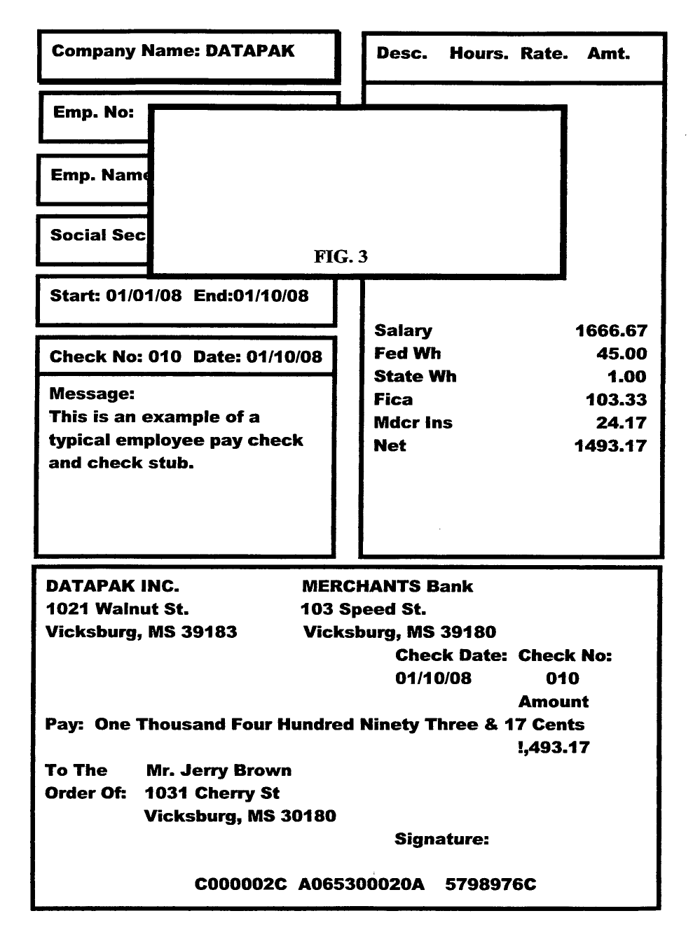

FIG. 3 is a view of an embodiment of a typical blank check and check stub that may optionally be used in the apparatus of the invention to concurrently apply both the normally pre-printed check and check stub format and the conventional employee payment information during the check printing process.

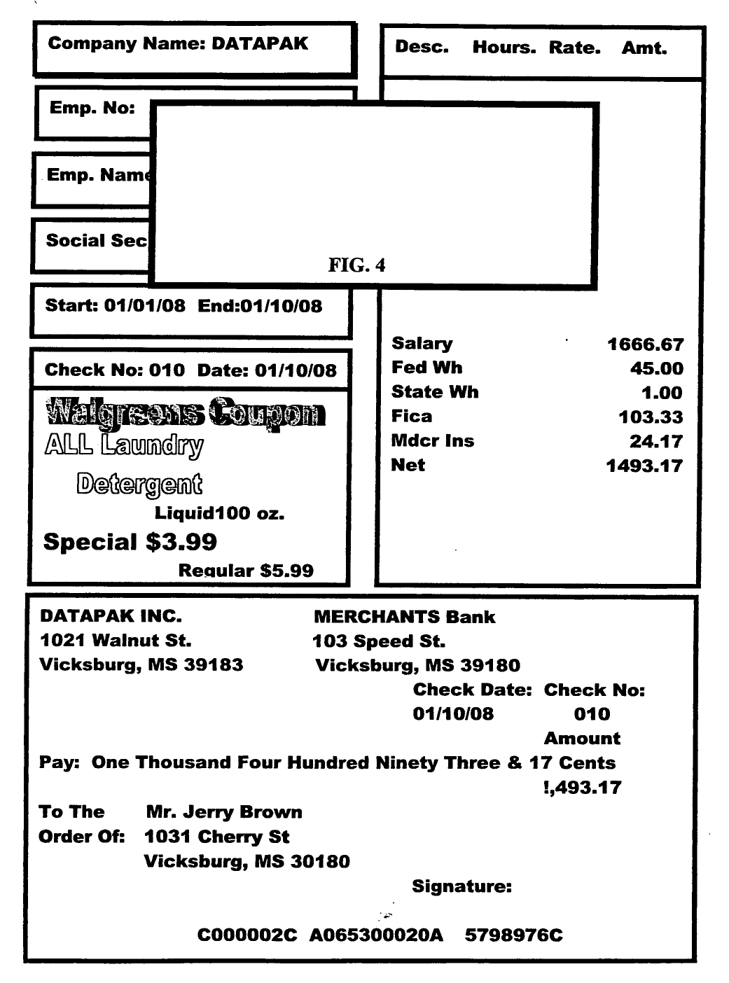

An object of the invention is to provide an Application of Printed Media onto a Payment Check Stub & Method of use Thereof that will display printed media including, advertisements, images, graphics, alerts and notifications, and a multitude of other information, on a payment check stub or payment receipt notification. FIGS. 4, 5 and 6 demonstrate three different applications.

An object of the invention is to provide an Application of Printed Media onto a Payment Check Stub & Method of use Thereof that will provide advertisers with a new way to target potential customers with advertisement for “point of sale” that may not be immediately lost or discarded in the process. FIG. 4 is an example of one such time-dependent application of the invention for consumer advertising. This feature employs the ability to alter the advertising immediately prior to each printing of the checks.

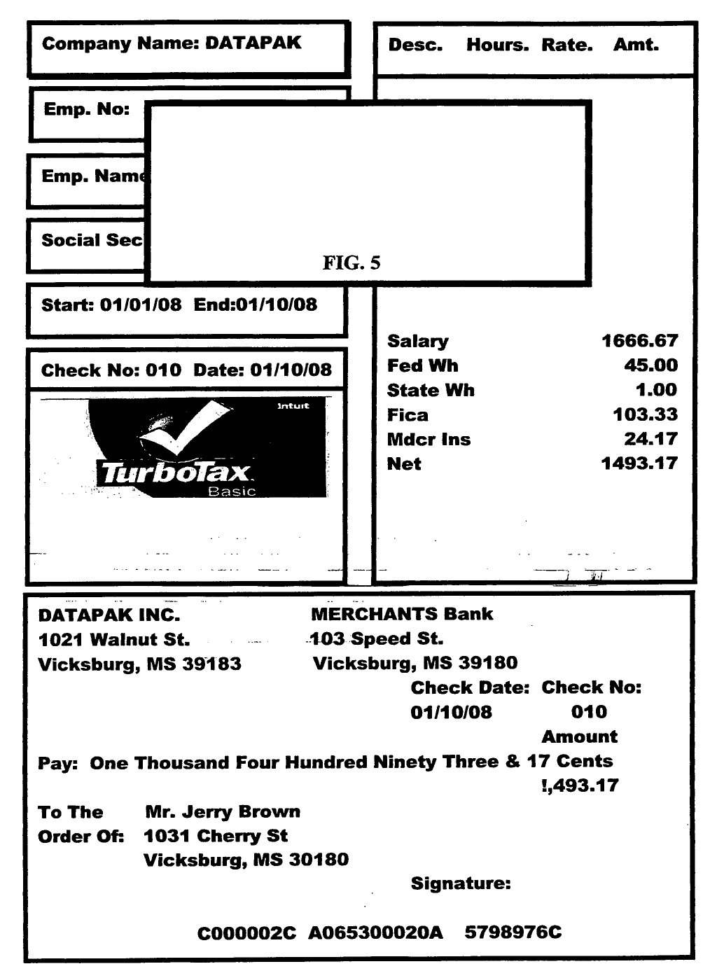

An object of the invention is to provide an Application of Printed Media onto a Payment Check Stub & Method of use Thereof that will provide advertisers with a new way to target potential customers with advertisement for product and service “branding” that may not be immediately lost or discarded in the process. FIG. 5 is an example of one such long time application of the invention for consumer advertising where the employee check stubs are normally retained for reference to employee earnings and deduction payments, etc.

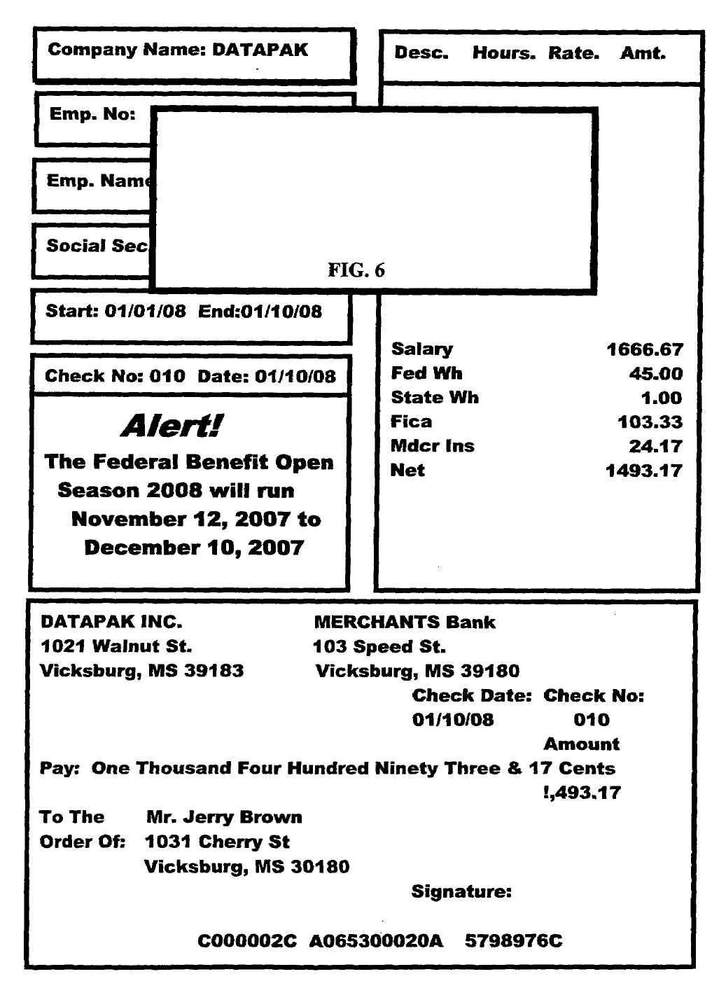

Another object of the present invention is to provide an Application of Printed Media onto a Payment Check Stub & Method of use Thereof that provides a new and useful way for businesses, corporations, and or governments to disseminate information to employees. FIG. 6 is an example of one such application where a Company or Government Agency may employ the invention to alert employees of a pressing forthcoming need for employee action.

The overall objective of the invention is to provide an Application of Printed Media onto a Payment Check Stub & Method of use Thereof which is a more precise and efficient method of reaching a target market with point of action and branding advertising than Prior Art applications.

The overall object of the invention is to provide an Application of Printed Media onto a Payment Check Stub & Method of use Thereof which is a more precise and efficient method of reaching a target audience with a plurality of images, graphics, alerts and notifications, and a multitude of other information than Prior Art applications.

In summary, the object of the invention is to provide an Application of Printed Media onto a Payment Check Stub & Method of use Thereof that is more universally functional in today's market than the Prior Art devices.

It is intended that all other advantages and objects of the present invention that become apparent or obvious from the detailed description or illustrations contained herein are within the scope of the present invention.

What is claimed:

1. The embodiment of the invention represents technology and innovation that supports an entirely new, surprising and untapped medium for “point of action” and “branding” advertising.

2. The embodiment of the invention represents technology and innovation that supports an entirely new, surprising and untapped medium for “conveying” corporate and government information to recipient citizens and employees in payments and paychecks.

3. The embodiment of the invention solves a long felt need of precisely advertising in printed word and graphic format on the “face” of payments and employee paycheck stubs that has been unsuccessfully until now.

4. The embodiment of the invention eliminates the long time requirement to create the advertising and/or information on the payment check stub via its pre-printing on the check stock well in “advance” of the payment or the checks actual use in printing.

5. The embodiment of the invention provides for the advertising and information to be presented “dynamically” and “automatically” at each processing of the employee and payment checks.

6. The embodiment of the invention creates a unique opportunity for advertising and communication of information to the 150-million US workers on payday and the 300-million US citizens on receipt of Government payments in a manner “not supported” by Prior Art.

7. The embodiment of the invention delivers advertising and information “directly” to the recipient eliminating their need for research and reading of magazines and newspapers and the computer literacy required of the Internet Search.
